(19) United States
(12) Patent Application Publication
(10) Pub. No.: US 2006/0004632 A1
(43) Pub. Date: Jan. 5, 2006

(54) Apparatus and method for distributing audiovisual content to a point of purchase location

(75) Inventors: Keith F. Kelsen, Scotts Valley, CA (US); Roger Binns, Scotts Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The MediaTile Company, Scotts Valley, CA (US)

(21) Appl. No.: 11/154,022

(22) Filed: Jun. 15, 2005

Related U.S. Application Data
(60) Provisional application No. 60/583,628, filed on Jun. 30, 2004.

(51) Int. Cl. G06F 17/00

(52) U.S. Cl. 705/14

(57) ABSTRACT

An advertising method for presenting an advertisement at a point of purchase includes transmitting advertising information from a server to a mobile telephone network; receiving the advertising information at the mobile telephone network; transmitting the advertising information from the mobile telephone network via a mobile telephone transmission to a display located at a point of purchase; receiving the mobile telephone transmission at the display; and playing an advertisement on the display based on the advertising information received by the display.

### CROSS-REFERENCE TO RELATED APPLICATION

This patent application claims priority to U.S. Provisional Patent Application No. 60/583,628, filed Jun. 30, 2004, titled “Method and Apparatus for Distributing Audiovisual Content Without On-Site Network Infrastructure, the disclosure of which is incorporated by reference herein in its entirety.

This patent application is related to U.S. Provisional Patent Application No. 60/467,615, filed May 5, 2003, titled “Video Sampler for Point of Purchase Messaging for Business Methods” the disclosure of which is incorporated by reference herein in its entirety.

### BACKGROUND OF THE INVENTION

The present invention generally relates to apparatus and methods for presenting an advertisement on a display. More particularly the present invention relates to an apparatus and a method for wireless transmission of advertisement information to a display located at a point of purchase. Embodiments of the invention obviate the use of on-site network infrastructure located proximate to a display wherein the on-site network infrastructure is configured to deliver advertisement information to a display that is located at the site, and more specifically is located at a point of purchase at the site.

Television, radio, print media, and billboard media have traditionally been used by advertisers to present advertisements to consumers to motivate the consumers to visit retail stores to purchase advertised merchandise. Advertisers that have used these media devices and techniques have traditionally garnered a major share of companies' annual advertising budgets that include billions of dollars.

As companies spend such amounts of money yearly to present their ads, consumers on average are presented with approximately 3000 advertising messages per day. Research has shown that an average person can hold about seven main ideas in short-term memory at a given time. As new advertisements are presented to consumers, older advertisements tend to be replaced in short term memory with the new ads. As such, much advertising is ineffective in influencing user behavior as the user has likely forgotten an earlier viewed ad by the time the user is ready to make a purchase. Specifically, over seventy percent of purchase decisions are made at the shelves of retailers' stores, if an advertisement for a product is not locally presented, then the possibility of the ad influencing a purchasing decision is relatively small.

To more persuasively influence purchasers' purchasing decisions, advertisers, manufacturers, merchants and the like are redirecting their advertising efforts to the point of purchase, i.e., the retailer's store shelves. To this end, billons of dollars are now spent annually for point of purchase advertising (also sometimes referred to as point of sale advertising). Point of purchase advertising includes the presentation of ads at store shelf where the majority of purchase decisions are made. Point of purchase adverting has grown from the use of relatively simple paper signage, to the user automatic coupon distribution, audio advertising, video advertising on electronic signs (e.g., digital displays) and the like.

Research further shows that advertisements for specific brands of products on digital signs at a point of purchase can raise sales of the branded products by as much as thirty percent, and can raise overall store revenues by as much as twelve percent. The site and action of digital signs that display television type advertisements are particularly influential to a consumer at a point of purchase, as the advertisements are timely delivered when a purchasing decision is being made. Because the ad is delivered at the point of purchase, the consumer not only has little or no time to forget the ad before making a purchase decision, but the ad is also not likely to be supplanted in the consumer's memory with other ads. To take advantage of the relatively strong influence of point of purchase advertising, over one billon dollars was spent annually in 2001, 2002, and 2003 on digital signage for point of purchase locations. Moreover, the digital signage industry for point of purchase advertising is expected to grow to a two billion dollar a year (or greater) industry by 2006.

A number of point of purchase advertising systems has recently been developed that includes networked (e.g., LAN networked) television monitors placed at point of purchase locations at a business site. These networked television monitors are typically communicatively coupled to a computer that is located at the site and might be configured to function as local network (e.g., a LAN) server to transfer advertisement information to the television monitors for play thereon. The computer is typically configured to receive advertisement information from via the Internet or via a hard storage media, such as magnetic tape, an optical disk, etc.

Maintaining a LAN at a business site is both complicated and costly. For example, the operability of most LANs is maintained by technician who specializes in the upkeep of LANS. Hiring such specialized technicians is typically costly, and is often cost prohibitive for small businesses. Not only is the cost of using and maintaining a LAN relatively high, the cost of purchased or leasing a LAN is also relatively high. Again, for some small businesses, these costs are often so high that the businesses receive no benefit from the use of such technology.

A number of manufactures produces advertising systems for point of purchase applications that use a LAN system that is located at a business site. For example, Scala, Inc. of Reston Va. manufactures an advertising system that uses unused bandwidth in a television channel to deliver advertising information to LAN system at a business site. The LAN's computer system is configured to extract the advertising information from the television channel, and transfers the advertising information to a point of purchase television for display of the advertisement. Other companies that manufacturer similar advertising systems include Video Arts System and Technology, Inc. of Sea Girt N.J.; The Videofax Company of New York N.Y.; uWink, Inc. of Los Angeles Calif.; and NewMedia Corporation of Alexandria Virginia. Other companies that manufacture advertising systems for point of purchase applications that include multiple LANs include Sony Corporation and Philips Electronics. While some traditional advertising systems configured for point of purchase use overcome some of the shortcomings of traditional media advertising (e.g., television, radio, print media, etc.), these advertising systems introduce inherent limitations, such as those described above.

Therefore, new advertising apparatus and advertising methods are needed that simplify and lower the cost of point of purchase advertising.

### BRIEF SUMMARY OF THE INVENTION

An advertising method for presenting an advertisement at a point of purchase includes transmitting advertising information from a server to a mobile telephone network; receiving the advertising information at the mobile telephone network; transmitting the advertising information from the mobile telephone network via a mobile telephone transmission to a display located at a point of purchase; receiving the mobile telephone transmission at the display; and playing an advertisement on the display based on the advertising information received by the display. According to one embodiment, the method further includes transmitting a request for the advertising information from the display to the server via another mobile telephone transmission. The server includes an advertisement provider and/or an SAS server. The method may further include transmitting an advertisement list from the server to the display via a second mobile telephone transmission; displaying the advertisement list on the display; receiving a selection from the advertisement list for the advertisement information; transmitting a request for the advertisement information from the display to the server via a third mobile telephone transmission; and receiving the request for the advertisement information at the server. The forgoing described steps obviate the use of a local network at a location of the point of purchase and configured to transmit the advertising information to the display.

According to another embodiment, an advertising system configured to present an advertisement at one or more points of purchase includes an advertisement provider configured to transmit advertising information to a mobile telephone network, wherein the mobile telephone network is configured to transmit the advertising information in a mobile telephone transmission; and at least one display located at a point of purchase and configured to receive the mobile telephone transmission and play an advertisement based on the advertisement information. According to a specific embodiment, the system further includes a scheduling server, such as an SAS server, configured to schedule a transmission of the advertising information from the advertisement provider to the display. The display includes a mobile telephone transceiver configured to receive the mobile telephone transmission.

Other features and advantages of the invention will be apparent in view of the following detailed description and accompanying figures.

### BRIEF DESCRIPTION OF THE DRAWINGS

FIG. 1 is a simplified schematic of a traditional advertising system;

FIG. 2 is a simplified schematic of an advertising system according to an embodiment of the present invention;

FIG. 3 is a simplified block diagram of a display included in the advertising system;

FIG. 4 is a simplified schematic of an advertising system according to another embodiment of the present invention;

FIG. 5A is an illustration of a display that is positioned at a point of purchase;

FIG. 5B is an illustration of another display that is positioned at another point of purchase;

FIG. 6 is a high-level flow chart having steps for an advertising method for presenting an advertisement at a point of purchase according to one embodiment of the present invention; and

FIG. 7 is a high-level flow chart having steps for transmitting display instruction between a display and the advertisement provider and/or the server according to one embodiment of the present invention.

### DETAILED DESCRIPTION OF THE INVENTION

The present invention provides an advertising apparatus and an advertising method for playing an advertisement at a point of purchase. More specifically the present invention provides an advertising system and method for delivering advertisement information via a mobile telephone link to a display that is located at a point of purchase and configured to play an advertisement associated with the received advertisement information.

Overview

Traditional advertising systems that are configured for point of purchase advertising typically include a local computer that receives advertisement information via the Internet or physical delivery (e.g., optical disk, cassette tape, etc), and then distributes the advertisement information via a local area network (LAN) to a television monitor located at a point of purchase. A point of purchase as referred to herein includes the location at which a purchaser is presented with a purchase option, such as an option to purchase a product or a service. For example, a point of purchase may be any location at or near a location where a product or a service is offered for customer purchase. For example, a point of purchase may include a store shelf at which a product is offered for sale, at an entry way to a business, at the entry to a department within a store, mounted to a store ceiling, on a counter, at an information kiosk, at a help desk or the like. For example, the point of purchase for a pair of shoes may include a shoe store rack on which a pair of shoes is displayed for purchase. According to one embodiment, the local computer is typically located at the same business location as the television monitor.

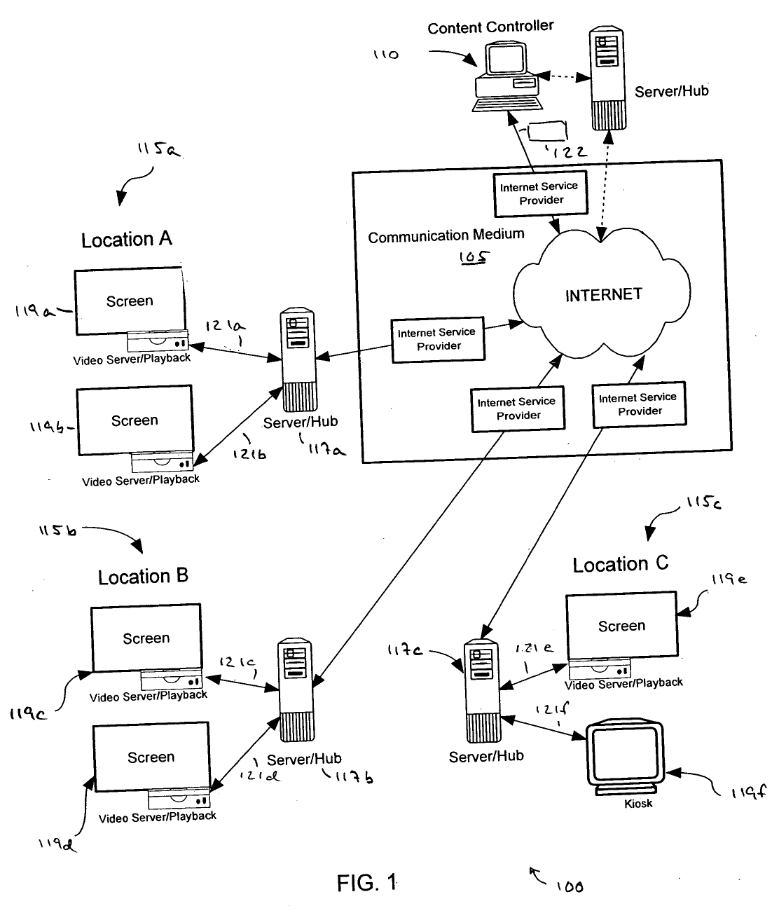

FIG. 1 is a simplified schematic of a traditional advertising system 100 that includes a content provider 110, a network 105 (e.g., the Internet), and first, second and third point of purchase systems 115a, 115b, and 115c. Advertising system 100 is configured to present an advertisement at a point of purchase. For convenience, point of purchase system 115a is described in further detail below. Point of purchase systems 115b and 115c are configured similarly to system 115a and are not described in detail. Point of purchase system 115a (located at a location A) includes a server 117a and first and second displays 119a and 119b. The server is communicatively coupled to displays 119a and 119b via a set of LAN links 121a and 121b, respectively. As referred to herein, a set includes one or more members. Sever 117a is configured to receive advertising information 122 from content provider 110 via network 105. Sever 117a is then configured to transfer via one or more of the LAN links the advertisement information to one or more of the displays to play an advertisement associated with the advertisement information. As each of the point of purchase systems includes a server that is network enabled and configured to distribute advertisement information via a LAN, these systems are costly and complex for businesses to purchase and operate. Specifically, a specialized technician is typically hired to maintain the server and LAN. Moreover, the cost of such systems is typically relatively high and often cost prohibitive for small businesses. Embodiments of the present invention are directed to addressing the foregoing described problems of traditional point of purchase systems as well as other problems described below.

Advertising System

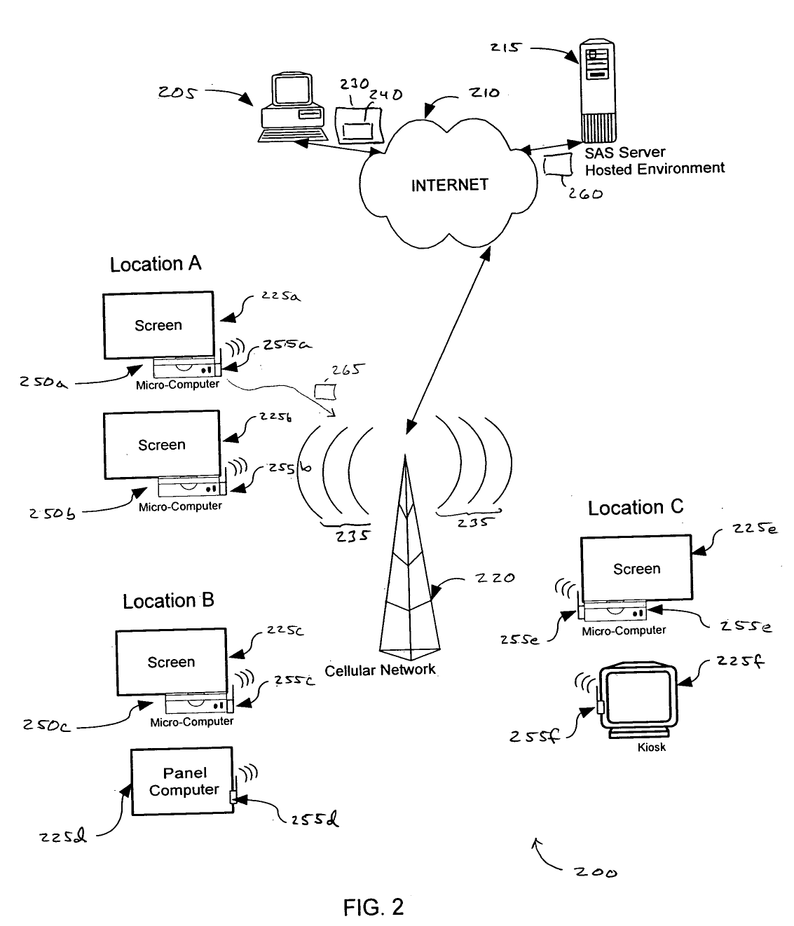

FIG. 2 is a simplified schematic of an advertising system 200 according to one embodiment of the present invention. Advertising system 200 includes an advertisement provider 205 (e.g., a server), a network 210 (such as the Internet), a server 215 (e.g., an SAS server), a mobile telephone network 220 (e.g., a cellular telephone network), and a set of displays 225. Advertising system 200 is configured to present advertisements at a point of purchase at which one or more of the displays may be located. A point of purchase as referred to herein includes the location (e.g., a store shelf) at which a purchaser is presented with a purchase option, such as an option to purchase a product or a service.

Advertisement provider 205 may include one or more computer systems and/or one or more databases communicatively coupled to network 210. The advertisement provider is configured to store and provide advertising information 230 for an advertisement. The advertising information may include audio data, video data, audio-video data (referred to herein as video data unless expressly indicated otherwise), still image data, text strings, computer code (e.g., computer code for an applet or the like that might be executed by a display) interactive data for interactive audio, video, still images and the like. According to one embodiment, the video data may include game data for games that might be played using one of the displays. These data might be transmitted from the advertisement provider in a variety of formats, such as MMS™ (multimedia messaging system), SMS (short message service), MMX™ formats, Macromedia™ Flash Player™ format, QuickTime™ format, one or more RealPlayer™ formats, Microsoft™ PowerPoint™, one or more MPEG formats, MP3 format or the like.

Advertisement provider 205 may be configured to transfer advertisement information 230 to mobile telephone network 220 substantially directly and/or via network 220. The advertisement information may be transferred from the advertisement provider 205 substantially directly to the mobile telephone network via a mobile telephone message using a mobile telephone protocol (e.g., a cellular protocol). The advertisement provider may transfer the advertisement information to the network via a network protocol (e.g., TCP/IP). The network may be configured to communicate with the mobile telephone network via a mobile telephone communication or a network communication to transfer received advertisement information to the mobile telephone network.

The mobile telephone network on receipt of the advertising information may transmit this information to one or more displays 225 located at one or more locations (e.g., locations A, B, and/or C). While the set of displays 225 shown in FIG. 2 includes six displays 225a-225f located at three locations, embodiments of the advertising system may advantageously include more or fewer displays located at one or more locations.

According to one embodiment, mobile telephone network 220 is configured to transmit advertisement information 230 via a mobile telephone transmission 235 to one or more of displays 225a-225f. The mobile telephone transmission may be a cellular transmission or the like. Each display 225 may be assigned a unique mobile telephone identifier (e.g., a mobile telephone number and/or an electronic serial number) that uniquely identifies the display. Alternatively, a plurality of the displays may be assigned a unique mobile telephone identifier. The advertisement information 230 transmitted from the advertisement provider may include a set of identifiers 240 that substantially match one or more mobile telephone identifiers assigned to the displays. The mobile telephone network 220 is configured to use the set of identifiers to transmit the advertisement information via transmission 235 to one or more displays.

According to one embodiment, each display 225 may include a computer 250 (e.g., a microcomputer) that is configured to send mobile telephone transmissions to and receive mobile telephone transmissions from the mobile telephone network. Computers 250a, 250b, 250c, and 250d, which are respectively associated with displays 225a, 225b, 225c, and 225d, are shown in FIG. 2. Computers that are associated with the “panel computer” display 250d and the “kiosk” display 250f are not shown. Panel computers, panel computer displays, kiosk displays and the like are well understood in the art and are not described in detail herein. The foregoing described display embodiments (e.g., screen display, panel computer, and kiosk) are described for exemplary purposes. Those of skill in the art will know of other displays that are configured to perform the functions described herein, and are considered to be within the scope and spirit of the present invention. Each computer 250 may include a mobile telephone transceiver 255 (label 255a-255f in FIG. 2) that is configured to receive the mobile telephone transmission. The transceivers may also be configured to transmit mobile telephone messages to mobile telephone network 220 for delivery of the messages to other displays, the advertisement provider, the server or the like. Each mobile telephone transceiver may be on a peripheral card (e.g., PCMCIA card) configured to be inserted into a peripheral slot (e.g., a PCMCIA slot) in a computer 250. Providing mobile telephone transceivers on peripheral cards provides for relatively simple change of a display's mobile telephone identifier by removing an old peripheral card and inserting a new peripheral card.

Each computer 250 on receipt of advertisement information 230 in a mobile telephone transmission, may store the advertisement information in a local storage device (e.g., hard disk drive, semiconductor memory, or the like). Further, on receipt of the advertisement information, a computer may direct its associated display to play the advertisement associated with the advertisement information. As the display playing the advertisement may be located at point of purchase, the advertisement may be pertinent to products and/or services offered for sale, lease, etc. at the point of purchase.

According to one embodiment, server 215 is an SAS (statistical analysis system) server configured to control communications between advertisement provider 205, mobile telephone network 220, and displays 250. For example, server 215 may be configured to schedule delivery of the advertisement information from the advertisement provider to the mobile telephone network and to one or more displays. It may be the case that server 215 is configured to store the identifiers for the displays and provide the identifiers to the advertisement provider for combination with the advertisement information for delivery to the displays. Alternatively, the advertisement provider may be configured to provide the advertisement information to the server that then transfers the advertisement information to the network and/or the mobile telephone system for further transfer to one or more displays.

According to another embodiment, server 215 is configured to track client billings and/or payments, schedule the delivery of advertisement information based, for example, on the client billings, the payments or the like. Sever 215 may be configured to log the delivery (e.g., delivery time and date) of each piece of advertisement information sent to each display. Server 215 may also be configured to track whether the advertisement provider has new advertisement information for delivery, and schedule the times and dates at which the new advertisement information is to be transmitted to one or more displays. The server may be configured to provide a play schedule to one or more of the displays such that the play schedule directs the displays to play that advertisement at given times and dates. For example, the play schedule may direct a display to play an advertisement during store hours, only during select hours when a promotional offer is to be presented or the like. The display schedule may be transmitted to one or more displays via the mobile telephone network. According to one embodiment, the display is configured to permit a user to schedule (e.g., via a scheduling presentation displayed on the display) the times and dates for which advertisements are to be played.

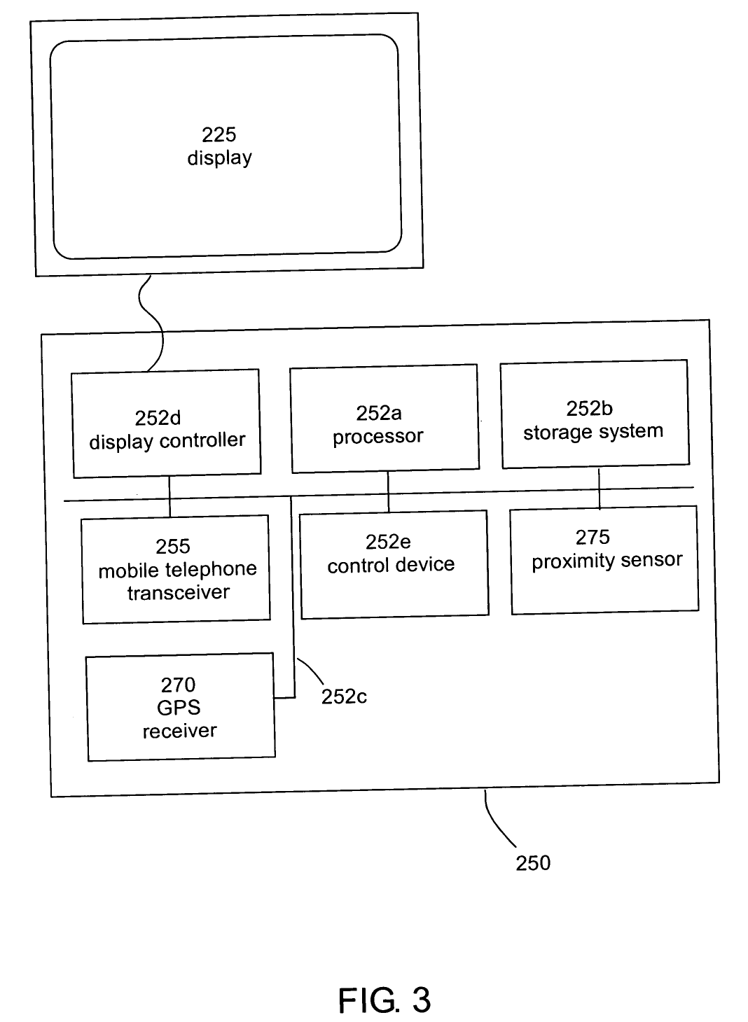

FIG. 3 is a simplified block diagram of one of the displays 225 and its associated computer 250 according to one embodiment of the present invention. Computer 250 includes a processor 252a, a storage system 252b, a bus 252c, a display controller 252d, a mobile telephone transceiver 255 (e.g., a peripheral card configured to be inserted into a peripheral slot), and a control device 252e. Processor 252a may be a microprocessor, a microcontroller, control logic or the like that is configured to execute program code that is stored in storage system 252b. Storage system 252b might include a variety of storage types, such as EPROMs, EEPROMs, SRAMs, DRAMs, optical disks (DVD, CD, etc.), magnetic storage (e.g., hard disk drive, tape drive, etc.), and the like. The storage system may include program code executable by the processor for controlling the playing of an advertisement for associated advertisement information stored in the storage system. The storage system may also include program code configured for controlling the mobile telephone transceiver for receiving the advertising information, and for storing the advertising information in the storage system. The storage system might include scheduling information supplied by the SAS server that is used by the processor for playing an advertisement based on the schedule. Further, the processor is configured to communicate via the bus for controlling the display controller for playing an advertisement on the display.

According to one embodiment, control device 252e includes a keyboard, mouse, joystick, button pad, and/or touch pad or the like for receiving user input from a user interacting with the computer. The control device may alternatively be configured to receive input from the display if the display includes a touch panel display, a button pad or the like for receiving user input.

According to one embodiment, the advertisement provider and/or the server is configured to send an advertisement list 260 to one or more displays 225 from which a user can select advertisement information. The advertisement list may include advertisement identifiers (e.g., titles), game titles or the like for products, services, and/or games offered by a merchant. Each computer 250 may be configured to direct its associated display to display the advertisement list on the display at the request of a user interacting with control device 252e. According to one embodiment, each control device includes a dedicated button or the like that is configured to trigger display of the advertisement list. The advertisement list may be organized such that each advertisement identifier displayed in the advertisement list at any given time is associated with a dedicated button or the like on the control device. For example, a given number (e.g., five) of advertisement identifiers included in the advertisement list may be displayed on a display at one time. Each advertisement identifier may be associated with a button or the like to select the advertisement for transmission from the advertisement provider and/or the server to the display. For example, five advertisement identifiers may be respectively associated with keys 1 through 5 of a keypad or the like. Associating the displayed advertisement identifiers with specific buttons or the like of a control device provides for relatively easy use by a user for selecting an advertisement she would like played on her display.

According to one embodiment, each computer 250 is configured to send a request 265 to the advertisement provider and/or the SAS server for the advertisement information associated with the selected advertisement identifier(s) selected by the user via the advertisement list. Request 265 may be a mobile telephone message that is sent from the mobile telephone transceiver of the computer to the mobile telephone network. The request may then be transferred to the advertisement provider and/or the SAS server via a mobile telephone message and/or the network. The advertisement provider in response to receiving the request may send requested advertisement information to the requesting display.

According to an alternative embodiment, the advertisement list 260 may be sent to a display with advertisement information for each advertisement identified in the advertisement list. The advertisement information for each advertisement may be locally stored in the display. If the user selects a given advertisement from the advertisement list, the display is configured to retrieve the advertisement information for the given advertisement from local memory and then play the advertisement.

According to another embodiment, one or more computers includes a GPS (global positioning satellite) receiver 270 that is configured to collect GPS signals from a set of GPS satellites to determine the location of the display. The collection of GPS signals is well understood in the art and will not be described in detail herein. A mobile telephone transceiver may be configured to transmit the determined position of the display in a mobile telephone message to the advertisement provider and/or the SAS server. The mobile telephone message that includes information for the determine position may be sent at the request of the advertisement provider or the server. The request might be sent to the display via a mobile telephone message, for example, if the display becomes lost or is stolen.

According to another embodiment, a display 225 includes a proximity sensor 275 that is configured to detect a person who is near the display. If the proximity sensor detects the person near the display, the processor is configured to control the display to play the advertisement. Proximity sensor technology is well understood in the art and will not be described in detail herein.

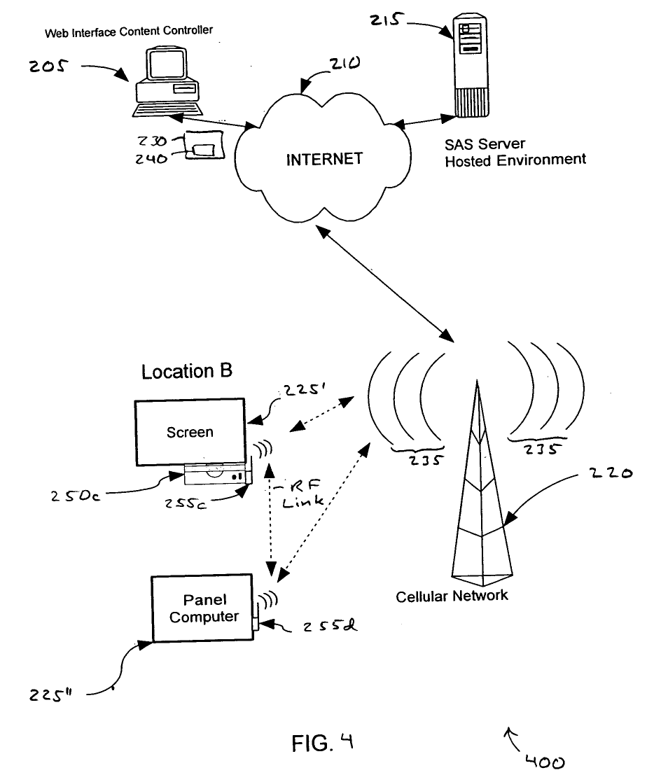

FIG. 4 is a simplified schematic of an advertising system 400 according to another embodiment of the present invention. Advertising system 400 differs from advertising system 200 described above in that at least one display 225′ is configured to transmit advertising information 215 to and/or receive advertising information 215 from another display 225″. These displays might be configured to transfer the advertising information via a wireless protocol, such as the WiFi protocol, the Bluetooth protocol, the Home RF protocol other wireless protocol, such as wireless protocol in use at the time. Display 225′ might be configured to send advertisement information to display 225″ if the advertising information is newly received by display 225′, if this display is requested (e.g., by the server) to send the advertising information. Aside from this difference between advertising system 200 and 400, advertising system 400 is configured substantially similar to and is configured to operate substantially similar to advertising system 200. To effect wireless transfer of advertising information between display 225′ and display 225″, these displays may include radio frequency transceivers, such as WiFi cards, Bluetooth stacks, or the like. Transfer of information between displays is sometimes referred to herein as peer-to-peer transfer.

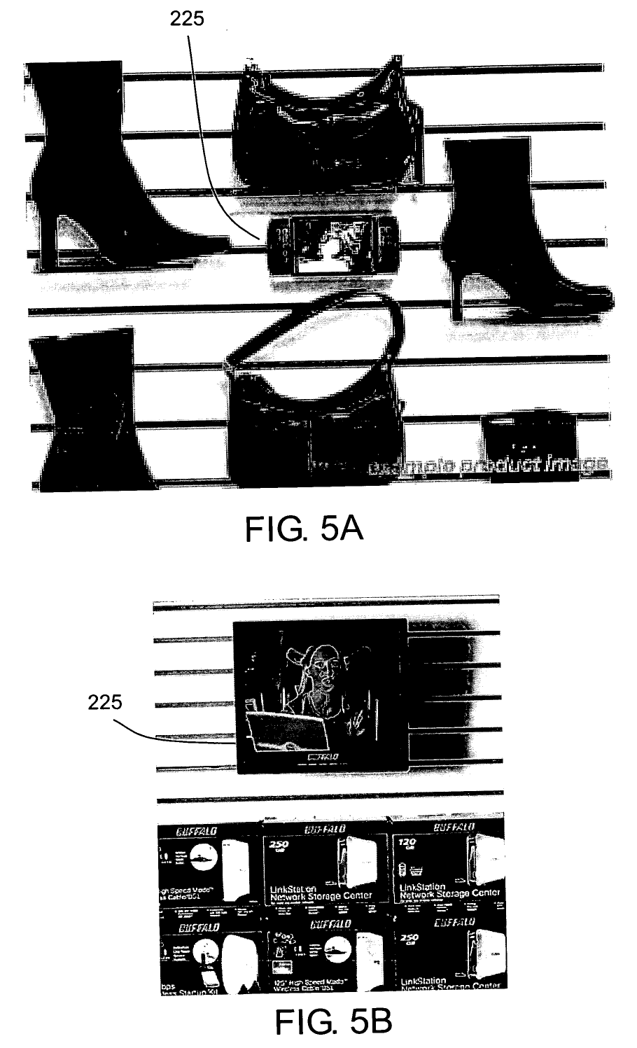

A display 225 may have a variety of sizes to accommodate different advertisers advertising needs. The diagonal dimension of a display may range from one or two inches to 100 inches or more. A display may include nearly any device configured to display an electronic image, such as a traditional television (CRT type display), a flat panel display (e.g., liquid crystal display, plasma display), a computer monitor, a holographic display, a projection display (e.g., a projection television or the like). FIG. 5A is an illustration of a display 225 that is positioned at a point of purchase (e.g., on a sales shelf). The diagonal dimension of the display may be eight to ten inches for convenient placement on the shelf. The display may be configured to display an add for one or more items offered for sale on the neighboring shelves such as boots, handbags or nearly any product or service that might be offered for sale, lease, or the like. For example, one or more display may be placed in a bank or the like to advertise banking services, in a manufacturing facility for playing training videos or the like, in a hospital, in a hospitality center of a hotel or the like to inform customers of hotel services, in a corporation (e.g., in a front lobby) to promote the companies product lines, in a school classroom, library, or the like to play educational videos for students, or in a variety of other locations. For example, a wine merchant may place a display in a grocery store's wine department to play video that directs customers in wine selection. For example, the display might be an interactive display in which a customer can enter a type of food they plan to serve at a party, and receive a wine suggestion for a particular winemaker's wine. FIG. 5B is an illustration of another display 225 that is positioned at a point of purchase (e.g., on a sales shelf). The diagonal dimension of the display may be nineteen inches to twenty seven inches or more. The display may be configured to play an advertisement for a product that is offered for sale at the point of purchase such as a computer network storage device or the like. It should be understood that the foregoing described advertisement embodiments are described for exemplary purposes and that the displays described herein may be placed at nearly any point of purchase that is associated with nearly any business or the like.

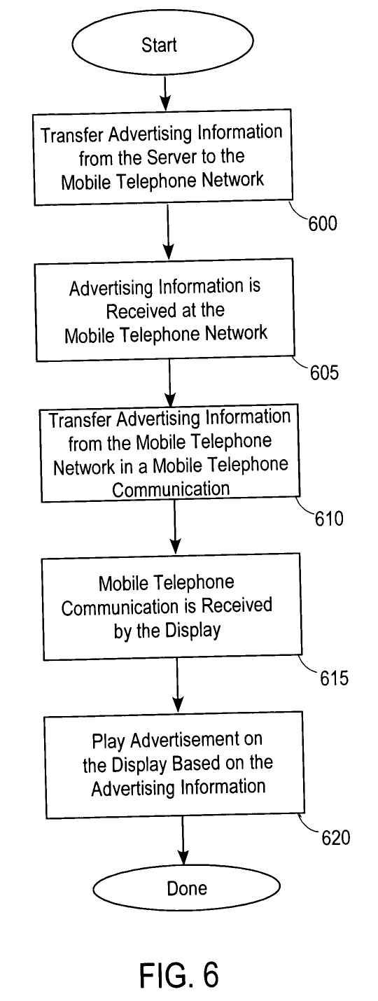

FIG. 6 is a high-level flow chart having steps for an advertising method for presenting an advertisement at a point of purchase according to one embodiment of the present invention. The high-level flowchart is merely illustrative of an embodiment incorporating the present invention and does not limit the scope of the invention as recited in the claims. One of ordinary skill in the art would recognize variations, modifications, and alternatives that incorporate the spirit and purview of the illustrative embodiment. At step 600, advertising information is transmitted from a server to a mobile telephone network. The advertising information may be transmitted from the server to the mobile telephone network via the Internet or the like. At step 605, the advertising information is received at the mobile telephone network. At step 610, the advertising information is transmitted from the mobile telephone network via a mobile telephone transmission to a display located at the point of purchase. The mobile telephone network is configured to use a mobile telephone number received with the advertising information to transmit the advertising information to a display associated with the mobile telephone number. At step 615, the mobile telephone transmission is received at the display. The display may extract the advertising information from the display and locally store the advertising information. At step 620, an advertisement that is associated with the advertisement information is played on the display. The advertisement may be played based on the detection of a person proximate to the display, a schedule locally stored in the display or remotely stored at the advertisement provider and/or the server, or the like. According to one embodiment, the display may send a confirmation message through the mobile telephone network to the advertisement provider and/or the server to confirm the receipt of the advertising information at the display. The confirmation message may be a text message, such as an SMS message or the like. The advertisement provider and/or the server may store the confirmation information.

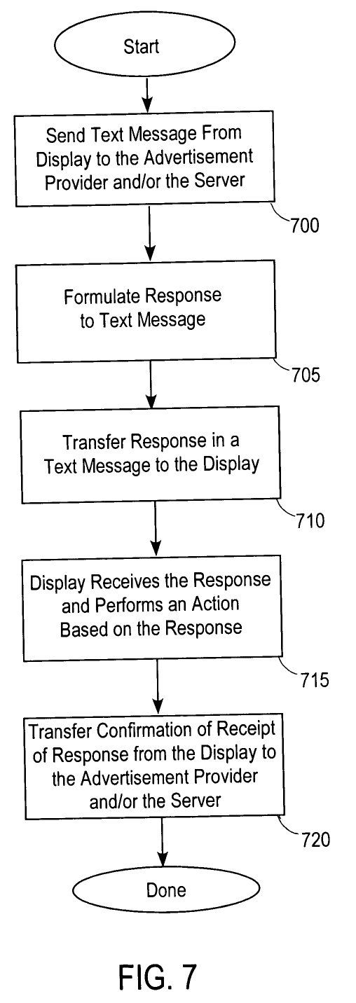

FIG. 7 is a high-level flow chart having steps for transmitting display instruction between a display and the advertisement provider and/or the server according to one embodiment of the present invention. The high-level flowchart is merely illustrative of an embodiment incorporating the present invention and does not limit the scope of the invention as recited in the claims. One of ordinary skill in the art would recognize variations, modifications, and alternatives that incorporate the spirit and purview of the illustrative embodiment. At step 700, the display sends a message (e.g., a text message, such as an SMS message) to the advertisement provider or the server to request information or provide requested information. The message may be a periodic “check in” message to: i) periodically (for example according to a schedule provided to the display by the server) let the advertisement provider know that the display is functioning properly, or ii) request a new advertisement that may be available. The message may alternatively include: i) a request for a specific advertisement (such as an advertisement identified in an advertisement list or the like), ii) interactive feedback to a query presented by the advertisement provider and/or the server via the display, iii) game interaction feedback, vi) a request for an advertisement list, v) a registration message for registering an initial time the display is used and/or after the display has been turn off, etc. According to another alternative, the message may include a request for help issued by a user of the display. The message may be sent from the display in a mobile telephone communication via the mobile telephone network.

According to one embodiment, an advertisement may be an interactive advertisement that is configured to provide interactive selection options from which a person viewing to the advertisement may select one or more of the selection options. The selection options may be for additional information for a product, a service, a game to be played or the like. A selection option selected by a person viewing the advertisement may be sent to the advertisement provide and/or the server in the message sent at step 700. The advertisement provider and/or server may collect information for the selected options for market research and the like.

According to one embodiment, the display may be configured to initiate communication (e.g., send the text message) with the advertising provider and/or the server. The advertising provider and/or the server may verify that the display attempting to communicate with the advertising provider and/or the server is a display that is registered for communication (e.g., registered to receive the advertising information) with these devices. The advertising provider and/or the server may very the display's mobile telephone number and/or the display's ESN. The ESN is the display's electronic serial number that uniquely identifies the display. The ESN may be a 32-bit control number or the like that is used for mobile (e.g., cellular) phone activation in mobile telephone networks (e.g., cellular telephone networks). The display's ESN uniquely identifies the display.

At 705, either the advertisement provider or the server may formulate a response to the received text message. It might be the case that a human user (e.g., in response to a help request) formulates the response. At 710, the response is sent to the display. The response may include a text message (e.g., an SMS message), advertisement information, an advertisement list, computer code, a game response, help instructions, etc. that is responsive to the message sent from the display. The response may be sent from the advertisement provider and/or the server in a mobile telephone communication via the mobile telephone network. At 715, the display receives the response and may perform one or more actions based on the response. At 720, the display sends a confirmation message to the advertisement provider or the server to confirm receipt of the response. The confirmation may be a text message (e.g., an SMS message or the like). The advertisement provider and/or the server may generate a record for each message received from and each response sent to each display.

It is to be understood that the examples and embodiments described above are for illustrative purposes only and that various modifications or changes in light thereof will be suggested to persons skilled in the art and are to be included within the spirit and purview of this application and scope of the appended claims. For example, while embodiments of the advertising system have been described as using a mobile telephone system that may be a cellular system for communicating advertising information between the advertisement provider and the displays, the mobile telephone system may be a satellite telephone system or other communication system in use at the time. As embodiments of the present invention advantageously use such communication systems, the displays according the present invention may be placed nearly anywhere in the world that can receive a mobile telephone communication. Therefore, a provider of the advertising system can manage the content manager and SAS server disposed a local facility while remotely managing displays that may be distributed locally or globally. Therefore, the above description should not be taken as limiting the scope of the invention as defined by the claims.

What is claimed is:

1. An advertising method for presenting an advertisement at a point of purchase comprising:
transmitting advertising information from a server to a mobile telephone network;
receiving the advertising information at the mobile telephone network;
transmitting the advertising information from the mobile telephone network via a mobile telephone transmission to a display located at a point of purchase;
receiving the mobile telephone transmission at the display; and
playing an advertisement on the display based on the advertising information received by the display.

2. The method of claim 1, further comprising transmitting a request for the advertising information from the display to the server via another mobile telephone transmission.

3. The method of claim 1, wherein the server includes an advertisement provider and/or an SAS server.

4. The method of claim 1, further comprising:
transmitting an advertisement list from the server to the display via a second mobile telephone transmission;
displaying the advertisement list on the display;
receiving a selection from the advertisement list for the advertisement information;
transmitting a request for the advertisement information from the display to the server via a third mobile telephone transmission; and
receiving the request for the advertisement information at the server.

5. The method of claim 4, wherein the step of transmitting the advertising information is responsive to the step of receiving the request.

6. The method of claim 4, wherein the request is formatted as a text message.

7. The method of claim 1, wherein the step of transmitting the advertising information from the server to the mobile telephone network includes:
transmitting the advertisement information from the server to a computer network; and thereafter
routing the advertisement information from the computer network to the mobile telephone network.

8. The method of claim 7, wherein the computer network includes the Internet.

9. The method of claim 1, wherein the advertising information transmitted from the server includes a mobile telephone number that identifies a mobile telephone transceiver associated with the display.

10. The method of claim 1, wherein the mobile telephone network is a cellular telephone network.

11. The method of claim 1, further comprising detecting a user located proximate to the display, wherein the playing step is executed based on the detecting step.

12. The method of claim 1, wherein:
the step of transmitting the advertising information from the server the mobile telephone network;
step of transmitting the advertising information from the server to the mobile telephone network; and
the step of transmitting the advertising information from the mobile telephone network via the mobile telephone transmission to the display located at the point of purchase;
are executed based on a schedule maintained by the server.

13. The method of claim 1, wherein the display includes a kiosk.

14. The method of claim 1, further comprising transmitting the advertising information from the first mentioned display to a second display via a wireless communication link.

15. The method of claim 14, wherein the wireless communication link is a WiFi link, a Bluetooth link, and/or a Home RF link.

16. The method of claim 1, wherein the steps of:
transmitting the advertising information from the server to the mobile telephone network;
receiving the advertising information at the mobile telephone network;
transmitting the advertising information from the mobile telephone network via the mobile telephone transmission to the display located at the point of purchase;
receiving the mobile telephone transmission at the display; and
playing the advertisement on the display based on the received advertising information,
obviate the use of a local network at a location of the point of purchase and configured to transmit the advertising information to the display.

17. The method of claim 1, wherein the advertisement information includes text, audio, and/or visual information for the advertisement.

18. The method of claim 1, wherein the advertisement information is formatted according to the MMS™ (multimedia messaging system) format, the SMS (short message service) format, the MMX™ format, the Macromedia™ Flash Player™ format, the QuickTime™ format, one or more RealPlayer™ formats, Microsoft™ PowerPoint™, and/or one or more MPEG formats.

19. The method of claim 1, further comprising storing the advertisement information at the display for subsequent play.

20. The method of claim 19, further comprising playing the advertisement on the display according to a schedule stored on the display.

21. The method of claim 1, further comprising:
collecting GPS signals from a plurality of GPS transmitting stations to determine the location of the display; and
transmitting location information for the location via a second mobile telephone transmission to the server.

22. The method of claim 21, further comprising transmitting the location information if a request to transmit the location information is received by the display.

23. The method of claim 22, wherein the request is sent via a third mobile telephone communication from the server to the display.

24. The method of claim 1, further comprising transmitting confirmation information indicating the display received by the advertisement information, wherein the confirmation information is transmitted via another mobile telephone communication from the display to the server.

25. The method of claim 24, wherein the confirmation information is an SMS message.

26. An advertising system configured to present an advertisement at one or more points of purchase comprising:
an advertisement provider configured to transmit advertising information to a mobile telephone network, wherein the mobile telephone network is configured to transmit the advertising information in a mobile telephone transmission; and
at least one display located at a point of purchase and configured to receive the mobile telephone transmission and play an advertisement based on the advertisement information.

27. The system of claim 26, further comprising a scheduling server configured to schedule a transmission of the advertising information from the advertisement provider to the display.

28. The system of claim 27, wherein the scheduling server is an SAS server.

29. The system of claim 27, wherein the display includes a mobile telephone transceiver configured to receive the mobile telephone transmission.

30. A method for presenting an advertisement at a point of purchase comprising:
transmitting advertising information from a server via a mobile telephone communication to a display located at the point of purchase;
receiving the mobile telephone transmission at the display; and
playing an advertisement on the display based on the received advertising information.
